(19) United States
(12) Patent Application Publication
(10) Pub. No.: US 2008/0117224 A1
(43) Pub. Date: May 22, 2008

(54) Image display apparatus and image display method

(75) Inventor: Yoshio Kimura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/907,047

(22) Filed: Oct. 9, 2007

(30) Foreign Application Priority Data
Nov. 21, 2006 (JP) 2006-314618

(51) Int. Cl. G09G 5/39

(52) U.S. Cl. 345/531

(57) ABSTRACT

According to one embodiment, there is provided an image display apparatus including: a memory storing data; a memory controller causing image data of an image for display at a startup time to be stored in the memory, before a power state shifts to a standby state; and a display controller reading the image data stored in the memory and causing the image for display at the startup time to be displayed, when the power state returns from the standby state.

### CROSS-REFERENCE TO RELATED APPLICATIONS

This application is based upon and claims the benefit of priority from Japanese Patent Application No. 2006-314618, filed Nov. 21, 2006, the entire contents of which are incorporated herein by reference.

### BACKGROUND

1. Field

One embodiment of the invention relates to an image display apparatus and an image display method suitable for a digital television broadcast receiving apparatus.

2. Description of the Related Art

As has been generally known, in a digital television broadcast receiving apparatus, when a power switch is turned on while power is supplied, a MPU (Micro Processor Unit) activates an application controlling a receiving function to obtain program data, decoding processing is applied to the obtained program data, and the resultant image is displayed on a display panel. Therefore, it takes a long time to output the image after the application is started.

If the aforesaid application uses an OS (Operating System), the startup time of the OS is also needed. If the application operates in a RAM (Random Access Memory), the development time of an application program from a ROM (Read Only Memory) to the RAM is further added.

Japanese Patent Application Publication (KOKAI) No. 2005-202105 discloses an electronic apparatus in which a CPU different from a CPU of an apparatus main controller is provided in a display controller, and while the activation of the CPU of the apparatus main controller is under preparation, the activation of the display controller is completed and a startup screen is displayed under the control of the display controller.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the schematic configuration of a digital television broadcast receiving apparatus;

FIG. 2 is an exemplary flowchart to describe a processing operation when power is supplied to the digital television broadcast receiving apparatus;

FIG. 3 is an exemplary flowchart to describe a processing operation when the digital television broadcast receiving apparatus shifts from a standby state to a normal operation state and when it shifts from the normal operation state to the standby state; and

FIG. 4 is an exemplary flowchart to describe a processing operation when the digital television broadcast receiving apparatus shifts from the standby state to the normal operation state and when it shifts from the normal operation state to the standby state.

### DETAILED DESCRIPTION

Various embodiments according to the invention will be described hereinafter with reference to the accompanying drawings. In general, according to one embodiment of the invention, there is provided an image display apparatus including: a memory storing data; a memory controller causing image data of an image for display at a startup time to be stored in the memory, before a power state shifts to a standby state; and a display controller reading the image data stored in the memory and causing the image for display at the startup time to be displayed, when the power state returns from the standby state.

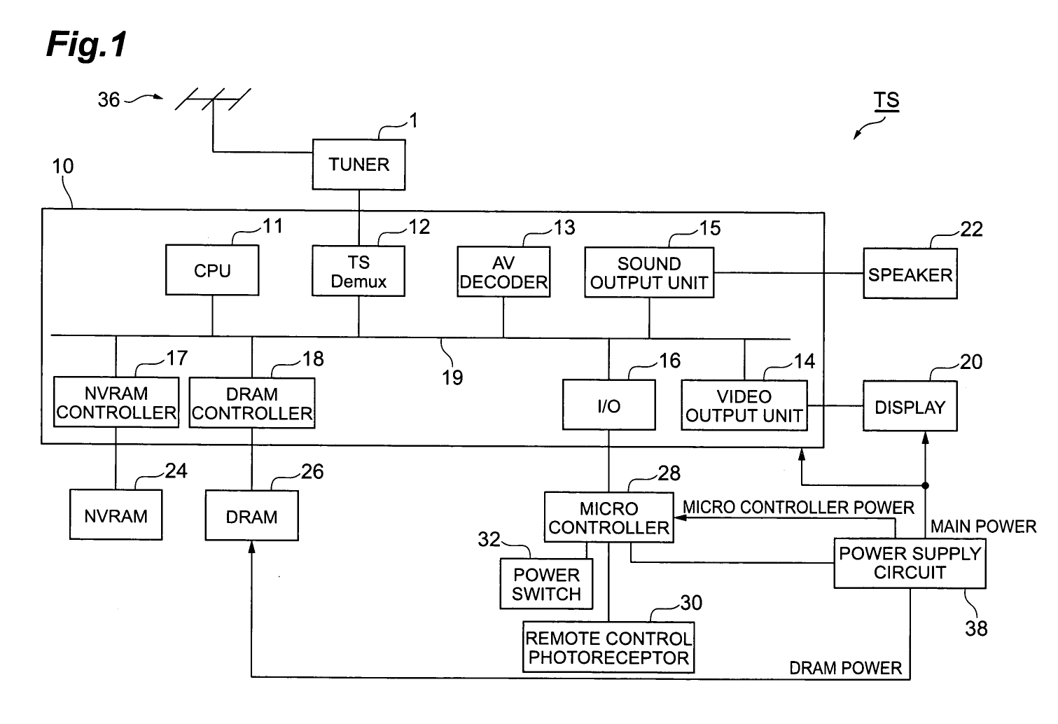

First, the configuration of a digital television broadcast receiving apparatus TS according to this embodiment will be described with reference to FIG. 1. In the following description, the same elements or elements having the same functions are denoted by the same reference numerals and symbols, and repeated description thereof will be omitted.

As shown in FIG. 1, the digital television broadcast receiving apparatus TS includes a tuner 1, a system LSI (Large Scale Integration) 10, a display 20, a speaker 22, a NVRM (Non Volatile Random Access Memory) 24, a DRAM (Dynamic Random Access Memory) 26, a micro controller 28, a remote control photoreceptor 30, and a power switch 32.

A digital television broadcast signal received by an antenna 36 is outputted to the tuner 1. The tuner 1 tunes to a digital television broadcast signal of a desired channel. The digital television broadcast signal tuned to by the tuner 1 is outputted to the system LSI 10.

The system LSI 10 includes a CPU (Central Processing unit) 11, a TSDemux (Transport Stream De-multiplex) 12, an AV decoder 13, a video output unit 14, a sound output unit 15, an I/O 16, a NVRM controller 17, and a DRAM controller 18. The CPU 11, the TSDemux 12, the AV decoder 13, the video output unit 14, the sound output unit 15, the I/O 16, the NVRAM controller 17, and the DRAM controller 18 are connected to one another via a bus 19.

The CPU 11 transmits control signals to the TSDemux 12, the AV decoder 13, the video output unit 14, the sound output unit 15, the NVRAM controller 17, and the DRAM controller 18 to control them.

The TSDemux 12 applies error correction processing, descramble processing, and TS packet conversion processing to the digital television broadcast signal outputted from the tuner 1. The TSDemux 12 separates packets of video signals (video data) and packets of sound signals (sound data) from a packet generated by the conversion to supply the separated packets to the AV decoder 13.

The AV decoder 13 applies decode processing in conformity to compression coding such as, for example, MPEG (Moving Picture Experts Group) compression coding to the packetized video data inputted from the TSDemux 12. The AV decoder 13 outputs the decoded video data to the video output unit 14.

The AV decoder 13 applies decode processing in conformity to compression coding such as, for example, MPEG (Moving Picture Experts Group) compression coding to the packetized sound data inputted from the TSDemux 12. The AV decoder 13 outputs the decoded sound data to the sound output unit 15.

The video output unit 14 reproduces the video data outputted from the AV decoder 13 to output the resultant to the display 20. The display 20 is a display device constituted of a flat display such as, for example, a liquid crystal display or a plasma display, and displays video based on the video signal inputted from the AV decoder 13.

The sound output unit 15 converts the sound data outputted from the AV decoder 13 to an analog signal to output the analog signal to the speaker 22. The speaker 22 reproduces, as sound, the analog signal outputted from the sound output unit 15.

The NVRAM 24 is connected to the bus 19 via the NVRAM controller 17. In the NVRAM 24, a boot program, an OS (Operating System), application programs, and image data of an image for display at the startup time (hereinafter, referred to as “a startup image”) are stored.

The DRAM 26 is connected to the bus 19 via the DRAM controller 18. In the DRAM 26, the image data of the startup image is stored before the power state shifts to a standby state, as will be described later.

The micro controller 28 is connected to the bus 19 via the I/O 16. The remote control photoreceptor 30, the power switch 32, and a power supply circuit 38 are connected to the micro controller 28.

The remote control photoreceptor 30 receives a remote control signal transmitted from a remote controller (not shown) operated by a user and converts the remote control signal to an electric signal to transmit the electric signal to the micro controller 28. The power switch 32 is operated by a user and outputs a signal corresponding to the operation of the user to the micro controller 28.

The digital television broadcast receiving apparatus TS includes the power supply circuit 38. The power supply circuit 38 is structured to output powers in three systems, that is, a main power, a micro controller power, and a DRAM power. The main power is supplied to the system LSI 10 and the display 20. The micro controller power is supplied to the micro controller 28. The micro controller power and the DRAM power are constantly outputted irrespective of whether the digital television broadcast receiving apparatus TS is in a power ON state or in a power OFF state. The main power is outputted when the digital television broadcast receiving apparatus TS is in the power ON state.

The power supply circuit 38 is connected to the micro controller 28, and when a user operates the remote controller or the power switch 32 for turning on the digital television broadcast receiving apparatus TS, the micro controller 28 changes the state of the power supply circuit 38 so that the power supply circuit 38 outputs the main power. Since the DRAM power is constantly outputted, the power is supplied to the DRAM 26 even during the standby state, and the storage state of the DRAM 26 is maintained by its self-refresh function.

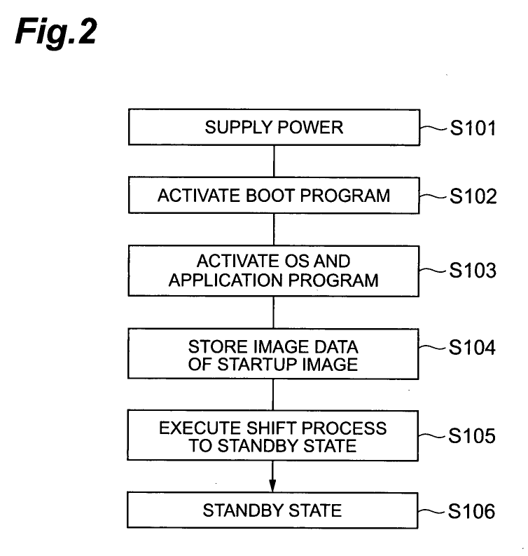

Next, with reference to FIG. 2, a description will be given of a processing operation of storing the image data of the startup image in the DRAM 26 when the power is supplied to the digital television broadcast receiving apparatus TS by the insertion of a power plug in a receptacle.

When the processing operation is started and the power is supplied (block S101), the micro controller 28 changes the state of the power supply circuit 38 so that the power supply circuit 38 supplies the main power to the system LSI 10. The micro controller 28 releases the reset of the system LSI 10, so that the system LSI 10 shifts to a startup sequence. The CPU 11 reads the boot program from the NVRAM 24 to activate the boot program (block S102). When the boot program is activated, the CPU 11 initializes the system LSI 10.

Next, the CPU 11 reads the OS and the application program from the NVRAM 24 to transfer them to the DRAM 26. Then, the CPU 11 activates the OS and the application program transferred to the DRAM 26 (block S103).

Next, the CPU 11 reads the image data of the startup image from the NVRAM 24 to transfer the image data to the DRAM 26. Consequently, the image data of the startup image is stored in the DRAM 26 (block S104).

Thereafter, the CPU 11 shifts the DRAM 26 to a self-refresh mode, and the micro controller 28 changes the state of the power supply circuit 38 so that the power supply circuit 38 stops the supply of the main power to the system LSI 10, and then the processing is ended (block S105). Consequently, the power state in the digital television broadcast receiving apparatus TS shifts to the standby state (block S106). In the standby state, since the DRAM 26 is supplied with the power from the power supply circuit 38, all the contents of the DRAM 26 are maintained, that is, not only data of the OS, the application programs, and the like but also their operating states are maintained. Therefore, the image data of the startup image is not lost and the storage state of the image data is also maintained.

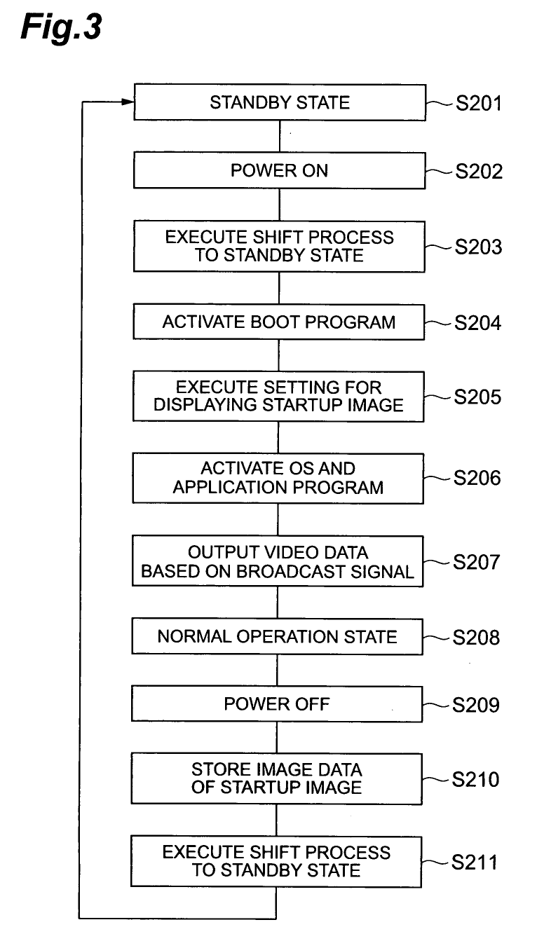

Next, with reference to FIG. 3, a description will be given of a processing operation when the digital television broadcast receiving apparatus TS shifts from the standby state to the normal operation state and when it shifts from the normal operation state to the standby state.

When the digital television broadcast receiving apparatus TS is in the standby state (block S201) and is then turned on by a user operating the remote controller or the power switch 32 (block S202), the digital television broadcast receiving apparatus TS returns from the standby state. When the digital television broadcast receiving apparatus TS is turned on, the micro controller 28 executes a shift process from the standby state (block S203). Here, the micro controller 28 changes the state of the power supply circuit 38 so that the power supply circuit 38 supplies the main power to the system LSI 10, and releases the reset of the system SLI 10. Consequently, the system LSI 10 shifts to a startup sequence.

The CPU 11 reads the boot program from the NVRAM 24 to activate the boot program (block S204). When the boot program is activated, the CPU 11 initializes the system LSI 10 to return the DRAM 26 to the normal operation state.

The CPU 11 executes the setting for causing the display 20 to display the startup image (block S205). Here, the CPU 11 executes initial setting of the video output unit 14, and also reads the image data of the startup image from the DRAM 26 to output the image data to the video output unit 14. The video output unit 14 reproduces the image data of the startup image to output the resultant to the display 20. Consequently, the startup image is displayed on the display 20. The startup image may be a still image or may be a moving image.

Further, the CPU 11 activates the OS and the application program (block S206). That is, the application program is activated in a state where the startup image has been displayed on the display 20.

When the application program is activated, a digital television broadcast signal tuned to by the tuner 1 is processed by the TSDemux 12 and the AV decoder 13 and video data is outputted to the video output unit 14, under the control of the CPU 11 (block S207). That is, the video data corresponding to the digital television broadcast signal received by the tuner 1 is generated based on the application program corresponding to the receiving function.

When the video data based on the digital television broadcast signal is outputted from the AV decoder 13, the video output unit 14 outputs the video data to the display 20 so that video based on the video data is displayed in place of the startup image, under the control of the CPU 11. Consequently, the video based on the digital television broadcast signal is displayed on the display 20, and the digital television broadcast receiving apparatus TS shifts to the normal operation state (block S208).

When the digital television broadcast receiving apparatus TS is in the normal operation state and is then turned off by the user operating the remote controller or the power switch 32 (block S209), the CPU 11 reads the image data of the startup image form the NVRAM 24 to transfer the image data to the DRAM 26. Consequently, the image data of the startup image is stored in the DRAM 26 (block S210).

Then, the CPU 11 shifts the DRAM 26 to the self-refresh mode, and the micro controller 28 executes a shift process to the standby state such as changing the state of the power supply circuit 38 so that the supply of the main power to the system LSI 10 is stopped (block S211), and the digital television broadcast receiving apparatus TS returns to block S201 to shift to the standby state. In the standby state, the DRAM 26 is supplied with the power from the power supply circuit 38 as described above, and therefore, the stored image data of the startup image is not lost.

When the digital television broadcast receiving apparatus TS is in the standby state (block S201) and is then turned on again (block S202), the digital television broadcast receiving apparatus TS returns from the standby state. When the digital television broadcast receiving apparatus TS is turned on, a shift process from the standby state is executed (block S203).

The CPU 11 reads the boot program from the NVRAM 24 to activate the boot program (block S204). When the boot program is activated, the CPU 11 initializes the system LSI 10.

The CPU 11 executes the setting for causing the display 20 to display the startup image (block S205). At this time, the image data of the startup image has been stored in the DRAM 26. Therefore, the CPU 11 executes initial setting of the video output unit 14, and also reads the image data of the startup image from the DRAM 26 to output the image data to the video output unit 14. The video output unit 14 reproduces the image data of the startup image to output the resultant to the display 20. Consequently, the startup image is displayed on the display 20.

The CPU 11 activates the OS and the application program stored in the DRAM 26 (block S206).

When the application program is activated, video data is outputted to the video output unit 14 under the control of the CPU 11, as described above (block S207).

When the video data based on a digital television broadcast signal is outputted from the AV decoder 13, the video output unit 14 outputs the video data to the display 20 under the control of the CPU 11 so that video based on the video data is displayed in place of the startup image. Consequently, the video based on the digital broadcast signal is displayed on the display 20. The digital television broadcast receiving apparatus TS shifts to the normal operation state (block S208), and then the processing is continued.

As described above, in this embodiment, the CPU 11 causes the image data of the startup image to be stored in the DRAM 26 before the power state of the digital television broadcast receiving apparatus TS shifts to the standby state after the power is supplied. Further, the CPU 11 causes the image data of the startup image to be stored in the DRAM 26 also before the power state of the digital television broadcast receiving apparatus TS shifts to the standby state after the digital television broadcast receiving apparatus TS is turned off. Then, when the power state returns from the standby state, the CPU 11 reads the above-mentioned image data pre-stored in the DRAM 26 to perform control so that the startup image is displayed on the display 20. Therefore, when the power state of the digital television broadcast receiving apparatus TS returns from the standby state, the time before the startup image is displayed can be shortened. Of course, it is possible for a user to easily recognize that the operation for activation is transmitted to the digital broadcast receiving apparatus TS.

In this embodiment, the CPU 11 causes the image data of the startup image to be stored in the DRAM 26 also before the power state of the digital television broadcast receiving apparatus TS shifts to the standby state after the digital television broadcast receiving apparatus TS is turned off. Therefore, it is not necessary to pre-set, in the DRAM 26, an area specialized for retaining the image data of the startup image.

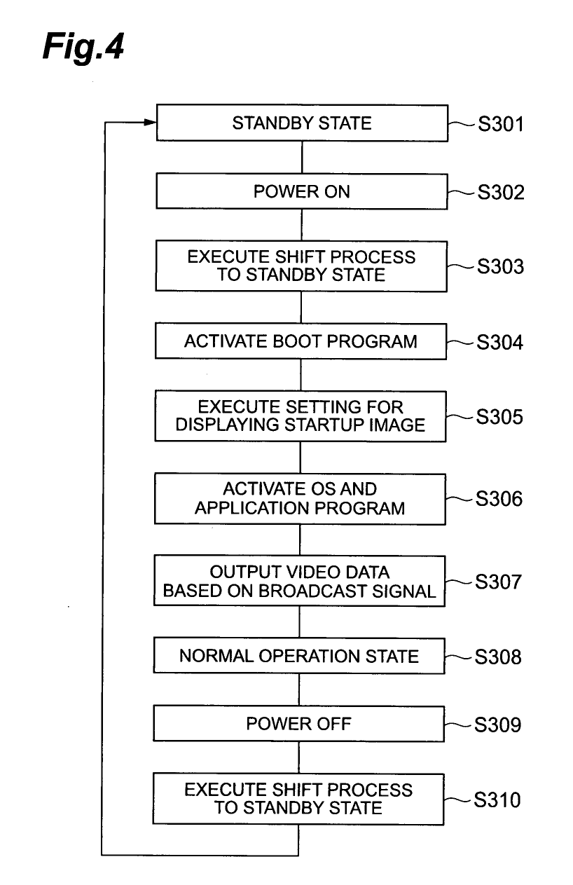

Next, with reference to FIG. 4, a description will be given of a processing operation as a modified example of this embodiment when the digital television broadcast receiving apparatus TS shifts from the standby state to the normal operation state and when it shifts from the normal operation state to the standby state. It is assumed here that the digital television broadcast receiving apparatus TS is in the standby state (the state at block S106 shown in FIG. 2) after the digital television broadcast receiving apparatus TS is supplied with power and the processes at blocks S102 to S105 shown in FIG. 2 are executed.

When the digital television broadcast receiving apparatus TS is in the standby state (block S301) and is then turned on by a user operating the remote controller or the power switch 32 (block S302), the digital television broadcast receiving apparatus TS returns from the standby state. When the digital television broadcast receiving apparatus TS is turned on, the micro controller 28 executes the shift process from the standby state as at block S203 (block S303).

The CPU 11 reads the boot program from the NVRAM 24 to activate the boot program as at block S204 (block S304).

Next, the CPU 11 executes the setting for causing the display 20 to display the startup image as at block S205 (block S305).

Further, the CPU 11 activates the OS and the application program stored in the DRAM 26 as at block S206 (block S306). At this time, the application program is activated in a state where the startup image has been displayed on the display 20.

When the application program is activated, a digital television broadcast signal tuned to by the tuner 1 is processed in the TSDemux 12 and the AV decoder 13 and video data is outputted to the video output unit 14, under the control of the CPU 11 (block S307).

When the video data based on the digital television broadcast signal is outputted from the AV decoder 13, the video output unit 14 outputs the video data to the display 20 under the control of the CPU 11 so that video based on the video data is displayed. Consequently, the video based on the digital television broadcast signal is displayed on the display 20, and the digital television broadcast receiving apparatus TS shifts to the normal operation state (block S308).

When the digital television broadcast receiving apparatus TS is in the normal operation state and is then turned off by the user operating the remote controller or the power switch 32 (block S309), the micro controller 28 executes the shift process to the standby state as at block 210 (block S310), and the digital television broadcast receiving apparatus TS returns to block S301 to shift to the standby state.

Also in the above-described modified example, the CPU 11 causes the image data of the startup image to be stored in the DRAM 26 before the power state of the digital television broadcast receiving apparatus TS shifts to the standby state after the power is supplied. Then, when the power state returns from the standby state, the CPU 11 reads the aforesaid image data pre-stored in the DRAM 26 to perform control so that the startup image is displayed on the display 20. Therefore, when the power state of the digital television broadcast receiving apparatus TS returns from the standby state, the time before the startup image is displayed can be shortened. Of course, it is possible for a user to easily recognize that the operation for activation is transmitted to the digital broadcast receiving apparatus TS.

Incidentally, in the above-described modified example, it is necessary to set, in the DRAM 26, an area specialized for retaining the image data of the startup image so as to prevent the image data from being rewritten.

Hitherto, the preferred embodiment of the invention has been described, but the present invention is not limited to the above-described embodiment, and various modifications can be made therein without departing from the spirit of the invention.

In this embodiment and its modified example, the data of the startup image is stored in the DRAM 26, but this is not restrictive. Any memory may be used, providing that it can maintain the storage state even when the power state is the standby state. For example, a SRAM (Static Random Access Memory) or a MRAM (Magnetoresistive Random Access Memory) may be used. The SRAM requires no refresh operation and therefore can retain data only by the supply of the power. The MRAM is a nonvolatile memory and therefore requires no power supply for retaining the data.

The invention is applicable not only to the digital television broadcast receiving apparatus shown as the embodiment but also to various electronic apparatuses displaying an image at the startup time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image display apparatus comprising:
a memory storing data;
a memory controller causing image data of an image for display at a startup time to be stored in said memory, before a power state shifts to a standby state; and
a display controller reading the image data stored in said memory and causing the image for display at the startup time to be displayed, when the power state returns from the standby state.

2. The image display apparatus according to claim 1,
wherein said memory controller causes the image data to be stored in said memory when power is supplied.

3. The image display apparatus according to claim 1,
wherein said memory controller causes the image data to be stored in said memory when the apparatus is turned off.

4. The image display apparatus according to claim 1,
wherein said memory controller reads the image data from a nonvolatile memory and causes the image data to be stored in said memory.

5. The image display apparatus according to claim 1,
wherein said display controller reads the image data from said memory and causes the image data for display at the startup time to be displayed, when the apparatus is turned on.

6. The image display apparatus according to claim 1,
wherein a storage state of said memory is maintained by the supply of power during the standby state.

7. The image display apparatus according to claim 1,
wherein said memory is a DRAM.

8. The image display apparatus according to claim 1, further comprising
a display controlled by said display controller to display an image.

9. An image display method comprising:
storing image data of an image for display at a startup time, before a power state shifts to a standby state; and
reading the stored image data and displaying the image for display at the startup time, when the power state returns from the standby state.
